(19) United States
(12) Patent Application Publication
(10) Pub. No.: US 2015/0034328 A1
(43) Pub. Date: Feb. 5, 2015

(54) GROUNDWATER REMEDIATION APPARATUS AND METHOD

(71) Applicant: Mohamed ABOUODAH, Overland Park, KS (US)

(72) Inventor: Mohamed ABOUODAH, Overland Park, KS (US)

(21) Appl. No.: 13/957,367

(22) Filed: Aug. 1, 2013

(51) Int. Cl. B09C 1/00

(52) U.S. Cl. CPC B09C 1/005
USPC 166/370; 166/188

(57) ABSTRACT

A well pipe provides for air sparging and soil vapor extraction for groundwater remediation at a single point of entry. An elongated well pipe is provided with a plurality of openings at an upper section and a lower section of the pipe and a packer member for separating the two sections. A conduit for delivering compressed air passes through the packer member into the lower section of the well tube for providing air sparging below the water table level in the ground and a vacuum source is connected to an upper end of the well pipe for drawing vapors from the vadose region in the ground into the pipe through the openings in the upper section of the well tube for transport on to a remediation destination. The conduit is adapted for delivery of remedial enhancing amendments into the surrounding ground through the lower section of the well pipe to further treat the contamination below the ground surface.

### FIELD OF THE INVENTION

The invention relates to soil and groundwater remediation and the removal of contaminant vapors from below the ground surface for treatment above ground. In particular, the invention relates to subsurface air sparging and soil vapor extraction.

### BACKGROUND OF THE INVENTION

Methods are presently being used for removing contaminant vapors from below the ground for treatment above ground. Soil vapor extraction and air sparging processes are commonly performed in two separate below grade structures and may generally be used in combination in performing such methods. Soil vapor extraction methods extract vapors from the soil vadose zone above the water table by applying a vacuum to pull the vapors out of the ground. Air sparging methods pump air underground to help extract vapors from groundwater and wet soil found beneath the water table. The pressurized air introduced through sparging promotes the chemicals to evaporate faster, and facilitates the soil vapor extraction process.

The soil vapor extraction method generally involves drilling one or more extraction wells into the contaminated soil to a depth above the water table. The air sparging method generally involves drilling one or more injection wells into the soil below the water table. Pressurized air is pumped into the groundwater through the injection wells, and as it bubbles through the groundwater, it carries contaminant vapors upward into the soil above the water table. The mixture of air and vapors is then pulled out of the ground through soil vapor extraction. The extracted air and vapors are then conveyed to a destination for treatment.

Generally, the extraction wells for the soil vapor extraction are spaced apart from the injection wells through which the pressurized air of the sparging process are placed, and the respective wells may be tens of feet apart. The spacing apart of the injection and extraction wells presents difficulties in capturing all of the air injected into the groundwater. In particular, there is often a migration of contaminants to clean areas in the soil, and an intrusion of contaminated vapors into surrounding structures. The uncollected contaminated air can result in serious health risks and possibly causing explosive conditions depending on the contamination. Furthermore, the associated trenching between the sparging and extraction points, and the extensive drilling, construction and maintenance that goes along with these tasks, creates additional costs.

It would be mechanically and financially desirable to provide an apparatus and method for groundwater remediation that combines the advantages of air sparging and soil vapor extraction at the same remedial point that is advanced into the soil and groundwater. It would also be desirable to provide an apparatus and method for allowing for the addition of amendments to the process at the remedial point to assist in the contaminant degradation and volatilization processes.

### SUMMARY OF THE INVENTION

The present invention provides an apparatus and method for combining the air sparging and soil vapor extractions processes for soil and groundwater remediation at a single installation point. An embodiment of the apparatus comprises an elongated well pipe with an upper internal section segregated from a lower internal section. Both upper and lower sections are provided with a plurality of openings that permit fluid and air communication between the inside of the well pipe and the surrounding soil. A packer element segregates the upper and lower sections in the interior of the well pipe. A conduit is disposed within the well pipe for introducing compressed air into the well pipe. The conduit passes through the packer element for delivery of the compressed air to the lower section. The packer restricts the delivered air to the lower section such that the compressed air exits through the openings in the lower section of the well pipe into the surrounding soil. A soil vapor extractor is operatively connected to the upper section of the well pipe and applies a vacuum to draw vapors into the well pipe through the openings in the upper section. The vapors drawn into the upper section of the well pipe are further conveyed to a treatment destination.

An embodiment of the method for remediating groundwater under the present invention provides for inserting the well pipe into an injection/extraction well in the ground at the remediation site. An assessment of the contaminated site should first be made to determine the depth to which the well pipe should be inserted into the ground which will dictate the respective placement of the openings of the upper and lower sections of the well pipe in the ground at the area of remediation. The air sparging step of the method requires placement of the openings of the lower section of the well pipe towards the bottom of the contamination to allow the delivered air to flow up through the zone of contamination. The soil vapor extraction step of the method requires placement of the openings in the upper section of the pipe over a region that spans from a point a few feet below the water table level up to several feet above the water table level into the vadose zone of the soil.

Compressed air is delivered to the well pipe through a conduit that runs down the well pipe, passes through the packer element and terminates in the lower section of the well pipe. The packer element restricts the compressed air from passing back through to the upper section so that the air is forced through the openings in the lower section into the surrounding soil for volatilization of contaminants. The sparging vapors carry contaminants upwards through the water table for ultimate extraction from the soil through the openings in the upper section of the well pipe via a vapor extraction process. A soil vapor extractor applies vacuum pressure to draw the vapors from the surrounding soil into the openings in the well pipe for conveyance to a treatment destination. In this arrangement and method, the air sparging and soil vapor extraction processes can occur at one remedial point.

In a further embodiment of the invention, remedial enhancing amendments for further chemical treatment of contaminants can be introduced into the well pipe for delivery into the soil along with the air sparging. The amendments can be delivered through the conduit carrying the compressed air.

These and other features of the present invention are described in greater detail below in the section titled DETAILED DESCRIPTION OF THE INVENTION.

### BRIEF DESCRIPTION OF THE DRAWING FIGURES

The present invention is described herein with reference to the following drawing figures, with greater emphasis being placed on clarity rather than scale:

FIG. 1 is a schematic view of the apparatus according to the present invention.

FIG. 2 is a view in side elevation of a portion of the well pipe according to the present invention.

FIG. 3 is a cross-sectional view in side elevation of the well pipe according to the present invention.

FIG. 4 is a cross-sectional view taken along line 4-4 in FIG. 3.

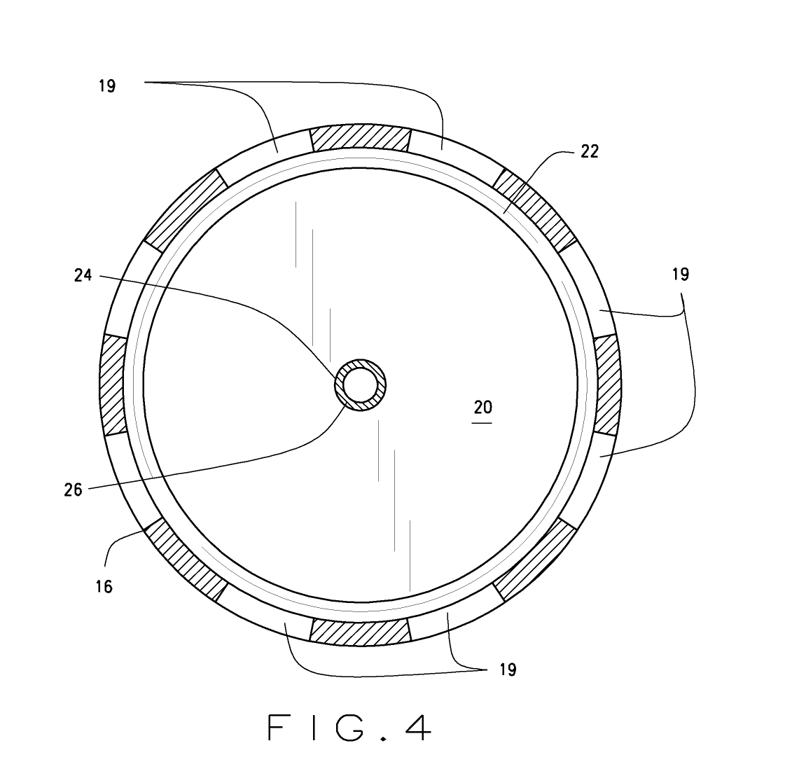

FIG. 5 is a cross-sectional view in side elevation of the well pipe showing the packer member.

### DETAILED DESCRIPTION OF THE INVENTION

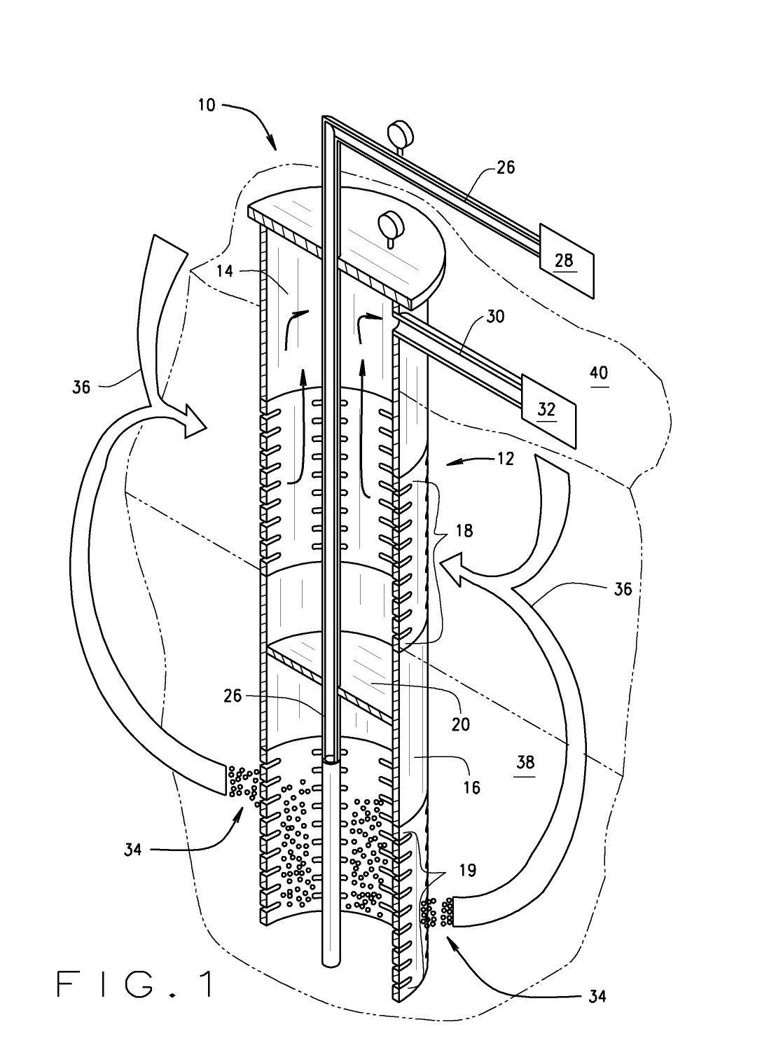

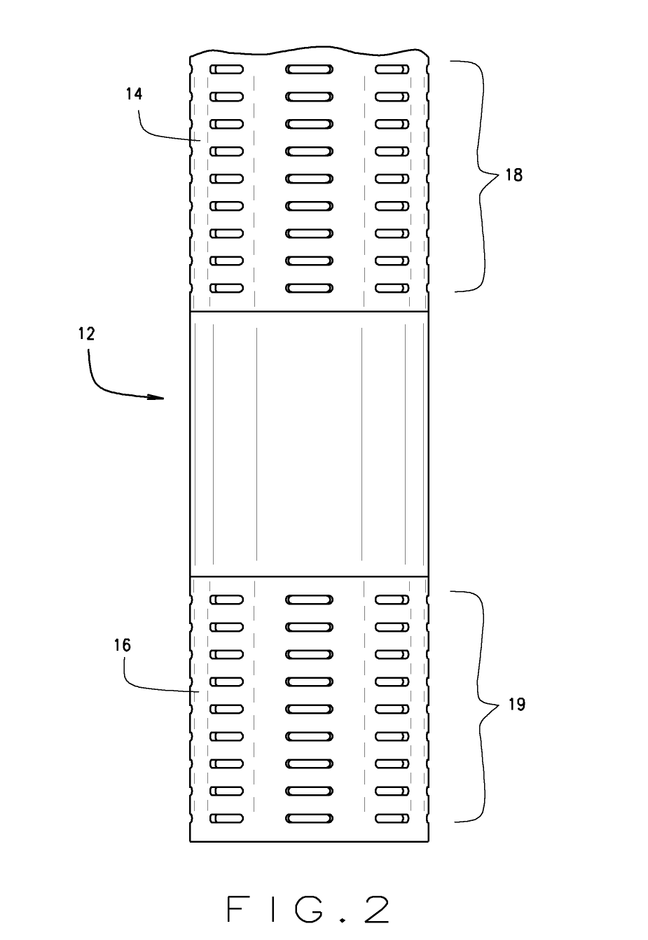

With reference to the drawing figures, an apparatus for combining air sparging and soil vapor extraction processes for groundwater and soil remediation of the present invention is herein described, shown, and otherwise disclosed in accordance with various embodiments of the present invention. The apparatus 10 is generally shown in FIG. 1. Apparatus 10 comprises an elongated well pipe 12 having an upper section 14 and a lower section 16. A plurality of openings 18 are formed in upper section 14 and a plurality of openings 19 are formed in lower section 16. The region of upper section 14, with its plurality of openings 18, is separated and spaced apart along well pipe 12 from the region of lower section 16, with its plurality of openings 19. As shown in FIG. 2, openings 18 and 19 comprise slots arranged laterally around the well pipe 12 in multiple rows to form a screen-like configuration. The openings are preferably of slot size 10, which has an opening width of 0.010 inches. The openings may be of slot size other than 0.010 inches, if desired. Slotted pipes such as this are well known and may be comprised of PVC or steel. Other slot and/or hole sizes and shapes may also be used depending on site geological conditions. The distance along well pipe 12 that the arrays are placed along the upper and lower sections may vary according to conditions presented by the remediation site (such as, for example, depth of the contamination area and geology of the ground at the contamination area), but each array will generally span around five feet vertically along the well pipe at the lower section region and 10 or more feet vertically along the well pipe at the upper section region. Well pipe 12 is closed at its bottom distal end.

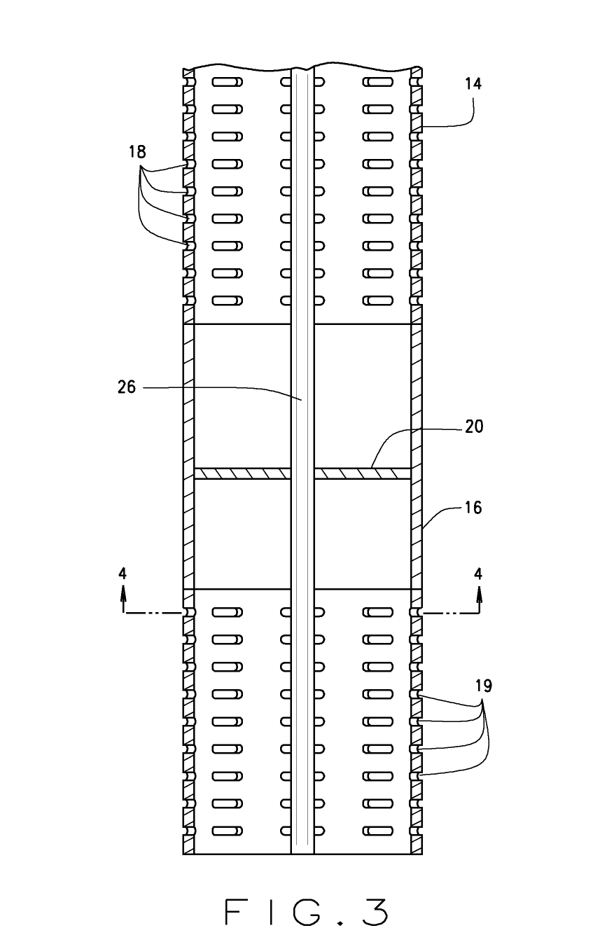

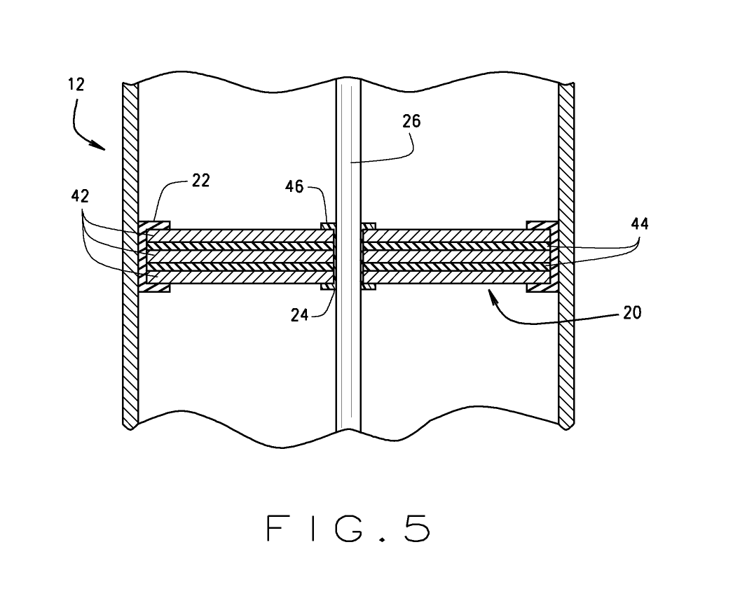

A packer member 20 is provided in well pipe 12 for segregating upper section 14 from lower section 16 as shown in FIG. 3. That is, the openings 18 in upper section 14 are positioned above packer member 20 and the openings 19 in lower section 16 are positioned below packer member 20. Packer member 20 is comprised of steel or plastic and is disk-shaped with a dimension approximating the internal diameter of well pipe 12. A gasket 22 is affixed to the peripheral edge of packer member 20 to ensure a firm engagement of the packer member within the well pipe. However, the engagement of the gasket with the internal wall surface of well pipe 12 does permit packer 20 to be moved along the internal wall surface within well pipe 12. Packer member 20 defines an opening 24 for receiving conduit 26 therethrough. One embodiment of packer member 20 comprises a stacked layer of steel discs 42 as shown in FIG. 5. Sandwiched between steel discs 42 are layers of rubber 44. A nipple 46 is placed, such as by welding, within opening 24 for receiving conduit 26 through packer 20. Nipple 46 permits conduit 26 to be rigidly connected with packer member 20 so that packer member 20 may be pushed or pulled by conduit 26 to adjust the placement of packer member 20 along the internal wall of well pipe 12. In an alternate embodiment (not shown in the drawings), packer member 20 may be adapted to slidably receive conduit 26 within opening 24 and a separate element, such as a rod, may be connected to packer member 20. In this alternate structure, the rod may be used to push or pull the packer element along the wall within the well pipe 12.

As shown in FIG. 1, conduit 26 extends from a top end of well pipe 12 down to lower section 16. Conduit 26 receives compressed air from source 28 (not shown) and delivers the air to the terminal end of conduit 26 in lower section 16. A soil vapor extraction line 30 communicates with well pipe 12 at its upper end and applies vacuum pressure from source 32 (not shown) for conveyance of vapor contents drawn from the surrounding soil into well pipe 12 to a treatment destination as is understood by those having skill in the art of groundwater remediation.

The apparatus is used in a method for combining air sparging with soil vapor extraction at a particular remedial point. Apparatus 10 is inserted into a well bore dug into the ground beforehand to serve as the injection/extraction well at the site selected for remediation. The particular depth to which the well bore is dug will depend upon a number of site factors as are well known to those skilled in the art of groundwater remediation, including the depth of the water table and the impacted vadose zone regions. Well pipe 12 may have a general length to accommodate the placement of the openings 18 in the upper section in the vadose region and openings 19 in the well pipe lower section 16 to be positioned near the bottom of the contamination in the ground site. The array of openings 19 may, for example, span over a five foot range along well pipe 12. The length of the range of openings can vary and will depend on a number of factors including the overall length of the well pipe, the relative positioning of the contamination in the water table and the depth of the vadose region. The preferred inner diameter of well pipe 12 is around four inches, but can be a larger or smaller diameter. The placement of the array of openings 18 in upper section 14 are designed to intersect the water table 38 and span to a range of around 10 feet above the water table 38 so as to lie in the vadose region 40 in the ground. FIG. 1 shows the general orientation of well pipe 12 and the array of openings 19 in lower section 16 and openings 18 in upper section 14 in the ground relative to the water table 38 and vadose region 40.

Conduit 26 is connected to a source of compressed air 28 for delivery to lower section 16 of well pipe 12 for the air sparging process. Conduit 26 passes through packer member 20 into lower section 16. Packer member 20 seals off lower section 16 from upper section 14 so compressed air 34 is forced to exit well pipe 12 through the array of openings 19 to infiltrate the surrounding soil at the region below the level of the water table as shown in FIG. 1. The placement of packer member 20 is adjustable within well pipe 12 so that the relative dimensions of upper section 14 and lower section 16 may be adjusted. The air mixes with and volatilizes the contaminants in the ground and rises up towards the vadose zone above the water table 38. Soil vapor extraction line 30 is connected to the near top of well tube 12 to be in communication with upper section 14. A vacuum source 32 applies vacuum pressure to soil extraction line 30 to draw vapors 36 from the vadose zone 40 into the upper section 14 of well tube 12 through the array of openings 18.

Thus, under the arrangement of the apparatus and method of the instant invention, air sparging and soil vapor extraction can be accomplished using a single piece of apparatus at a single remediation point. Depending upon the size of the area of contamination, however, multiple units of the inventive apparatus at additional single point injection/extraction wells may be employed at an overall remediation site.

In another embodiment of the invention, the apparatus can be used to add materials into the remediation site to facilitate chemical treatments or oxidation of contaminants. Materials can be delivered though conduit 26 along with the compressed air. Alternatively, a supplemental conduit (not shown) may be employed. Amendments may be any chemical (liquid or gas) that can be injected in the subsurface to treat the contamination at the site and are well understood in the art. The specific selection will depend on the contaminant to be treated, site geology and impact size. Amendments will be deployed when air sparging alone is not expected to be adequate to treat or remove the contamination. Air sparging alone may be adequate if the contaminants have a high Henry constant such as most chlorinated compounds contamination or benzene (referred to as volatile compounds). However, if the contaminant is semi-volatile or has low or no volatility and do not degrade aerobically, chemical treatment or oxidization may be necessary. That is when amendments are needed. Amendments may also be used in volatile compounds treatment when there is a desire to reduce the project life and to achieve objective at a faster rate.

The apparatus and method of the present invention provide significant advantages over remediation methods in which the soil vapor extraction process is performed at a remote distance from the air sparging process. In particular, having the soil vapor extraction occur at the same location as the air sparging helps to contain and gain increased control of the migration of contaminated vapors and minimize vapor intrusion to areas away from the vapor extraction site. Furthermore, having a single point of entry reduces intrusive entry into the ground by equipment and other structures over the remediation area arising from drilling, construction and maintenance associated with an extraction point that is removed from the air sparging point, which helps to reduce overall remediation project costs and provides added safety.

Although the invention has been disclosed with reference to various particular embodiments, it is understood that equivalents may be employed and substitutions made herein without departing from the scope of the invention as recited in the claims.

Having thus described the preferred embodiment of the invention, what is claimed as new and desired to be protected by Letters Patent includes the following:

1. An apparatus for combining air sparging and vapor extraction operations for groundwater remediation in soil at a single point in the ground, the apparatus comprising:
a) an elongated well pipe adapted for placement in the ground at a groundwater remediation site;
b) a conduit for introducing compressed air into the well pipe;
c) a packer for separating internal sections within the well pipe; and
d) a soil vapor extractor;
the well pipe comprising an upper section and a lower section terminating in a closed end, each of the sections comprising a plurality of openings through a wall of the well pipe, the packer being disposed in the well pipe between the upper and lower sections, the conduit being elongated and extending into the well pipe and through the packer to terminate in the lower section of the well pipe and having an outlet for delivering compressed air into the lower section, the packer blocking communication between the lower section and upper section such that the compressed air delivered into the lower well pipe exits through the openings in the lower section for sparging into the surrounding soil and water, the soil vapor extractor being in operative communication with the upper section of the well pipe for extracting vapors from the surrounding soil through the openings in the upper section of the well pipe.

2. The apparatus of claim 1 in which a conduit is provided for introducing materials into the well pipe for delivery into the soil, the conduit extending through the packer to terminate in the lower section of the well pipe for delivery of the materials through the openings in the lower section into the surrounding soil.

3. The apparatus of claim 2 in which materials are introduced into the well pipe through the conduit for delivering compressed air.

4. The apparatus of claim 1 in which the packer comprises a member being slidably engagable with the well pipe such that the position of the packer within the well pipe is adjustable.

5. The apparatus of claim 4 in which the respective lengths of the upper and lower sections of the well pipe are adjustable.

6. The apparatus of claim 4 in which the packer comprises a disk whose peripheral edge comprises one or more gaskets.

7. The apparatus of claim 1 in which the diameter of the well pipe is around four (4) inches.

8. The apparatus of claim 1 in which the openings in each of the upper and lower sections are positioned along the well pipe over a length of around a five (5) feet range.

9. The apparatus of claim 1 in which the openings have a diameter of around 0.010 inches.

10. The apparatus of claim 4 in which the packer is comprised of a plurality of steel discs.

11. A method for combining air sparging and vapor extraction operations for groundwater remediation in soil at a single point in the ground, the method comprising the steps of:
a) determining a depth in the ground to which soil contamination extends;
b) providing an elongated well pipe having a sufficient length to reach the contamination area in the soil;
c) configuring the elongated well pipe to have a segregated upper and lower section, each section having a plurality of openings through a wall of the well pipe;
d) providing a supply of compressed air to inject into the soil through the plurality of openings in the lower section of the well pipe; and
e) providing a soil vapor extractor to draw vapors from the soil into the upper section of the well pipe through the plurality of openings in the upper section of the well pipe; and
f) conveying the extracted vapors from the upper section of the well pipe to a treatment destination.

12. The method according to claim 11 in which the well pipe is placed into the soil to a depth such that the openings in the lower section of the well pipe are positioned at a lowest level of the contamination in the soil whereby air for the sparging process is introduced into the soil below the water table in the area of the contamination.

13. The method according to claim 11 in which the well pipe is placed into the soil to a depth such that the openings in the upper section of the well pipe are positioned above a water table level in the soil to receive vapors from the surrounding soil.

14. The method according to claim 11 in which a packer member is positioned in the well pipe to segregate the upper and lower sections, the packer member being slidably engagable with an internal surface of the well pipe for adjustable positioning within the well pipe.

15. The method according to claim 11 in which the well pipe is provided with a conduit for delivering materials to the contamination area into the soil.

16. The method according to claim 14 in which a conduit is disposed through the packer member for delivering materials through the openings in the lower section of the well pipe.

17. The method according to claim 16 in which the materials are delivered through the conduit for delivering compressed air.
